(19) United States
(12) Patent Application Publication
(10) Pub. No.: US 2012/0117776 A1
(43) Pub. Date: May 17, 2012

(54) FABRIC SLIP COVERING ACCESSORY FOR DISPOSABLE BABY WIPES CASE

(76) Inventors: Danielle Bourns, Bloomington, MN (US); Stephanie Bickman, Glendale, AZ (US)

(21) Appl. No.: 13/206,853

(22) Filed: Aug. 10, 2011

Related U.S. Application Data
(60) Provisional application No. 61/413,564, filed on Nov. 15, 2010.

(51) Int. Cl. B23P 11/00; A47K 17/00

(52) U.S. Cl. 29/428; 29/592

(57) ABSTRACT

A design and method of manufacture of decorative fabric covers for baby wipe cases, whereby the wipe cases are easily placed on and removed from the plastic wipe cases for cleaning purposes, and whereby the fabric cover is designed and manufactured to attach to the plastic wipe case tab opening, thereby making the fabric cover more useful, convenient, used as the wipe case manufacturer intended, and easier to open. Additionally, there is an option to attach additional pieces of fabric with a separate closure method that forms a storage pocket or strap to hold additional personal items.

### CROSS-REFERENCE TO RELATED APPLICATIONS

Not applicable

### STATEMENT REGARDING FEDERALLY SPONSORED RESEARCH OR DEVELOPMENT

Not Applicable

### BACKGROUND OF THE INVENTION

1. Field of Invention

The present invention relates to a method of manufacture of a decorative fabric cover for baby wipe cases, which are typically made of plastic. These baby wipe cases can be of various sizes and used for home or in smaller sizes used for travel. There are many people who use craft skills to make decorative covers for baby wipe cases, however, they are typically permanently attached to the wipe case making removal for washing difficult, and do not allow for only the wipe case tab to be opened to dispense wipes.

2. Background

Baby wipe cases come in a plastic case of various designs, shapes, sizes and colors, depending on the manufacturer and the number of wipes the case is designed to store. There are wipe cases made with decorative fabric; there is not an easy way to wash the fabric cover: currently craft makers are using a hot glue gun to secure fabric to the wipe case. This submitted invention allows the decorative fabric to easily slide on and off typically for the purpose of washing and cleaning, and it also allows the user to use the top opening to dispense the wipes from the plastic wipe case.

Many parents desire to purchase a decorative fabric cover for their baby wipe cases for various reasons, yet are not usually pleased after a period of time when the decorative fabric cover is stained and dirty with no way to easily wash the cover. In addition, when the fabric cover is purchased, the consumer (parents) usually do not realize that the decorative cover made dispensing wipes more difficult, and in many cases, the consumer may have to purchase a new wipe case if they want a new cover since the cover cannot be removed.

Various embodiments of the present invention relate generally to the manufacture of decorative slip covers for baby wipe cases, and more particularly, providing a novel way to keep dispensing of the wipes as designed by the wipe case manufacturer and providing a novel way to allow the consumer (parent) to quickly and easily remove the case for cleaning or washing.

It has been proposed to manufacture the fabric slip cover with an easy method to open and seal the cover, such as Velcro, and to use a novel approach to custom manufacture the fabric so that an opening tab will match the opening tab of the plastic case and attach to the opening tab of the plastic case, such that the user can open the plastic case tab with the same general ease as without the fabric slip cover. Some plastic wipe cases are difficult to open for many parents, and especially other caregivers such as older siblings or grandparents, because the manufacturer of the wipe cases create a tight seal enclosure in order to keep air out of the case, thereby keeping the wipes moist. However, this can make the tab seal so tight, that it is difficult to open. Another embodiment of this invention is that by using the attached fabric slip cover tab, the plastic wipe case is easier to open because there is fabric for the user to grab onto to pull the tab.

The present disclosure embodies a number of aspects that can be implemented separately from or in combination with each other.

While the preferred embodiments of the invention have been described above, it will be recognized and understood that various modifications may be made therein and the appended claims are intended to cover all such modifications that may fall within the spirit and scope of the invention.

### DEFINITION OF TERMS

### Baby Wipe Case, Plastic Case, Wipe Case

A plastic casing made specifically for baby wet wipes made of plastic or cloth used to cleanse the skin of infants. The plastic case is sealed to prevent air from coming inside which would dry out the wetness of the wipes. The plastic case has some method to open such as a plastic tab or finger tab to open the entire top.

### Baby Wipe, Wet Wipe, Wet Nap, Wet Towel, Moist Towelette

These interchangeable terms refer to the moist wipe that is individually placed into a plastic container with a dispensing method. There are multiple uses of such wipes including but not limited to, cleansing infants, washing hands, personal hygiene, pet care, and general cleaning

### Wipe Dispensing Tab, Dispenser Tab, Plastic Wipe Case Tab

The opening of the wipe case that allows the user to remove one or more wipes from the case, then close and reseal the case.

### Fabric Slip Cover

Any fabric decorative in nature that adds to the style of any wipe case, and is able to slip on and slip off easily.

### Dispenser Tab Wipe Cover

A matching fabric cover to the manufactured design of the baby wipe case which includes a method of securing said fabric cover to the dispenser tab, including, but not limited to, an elastic band, Velcro, Velcro stickers, magnet, snaps, additional fabric, zipper, or reusable tape.

### Fabric Slip Cover Seal or Enclosure

The material and method by which the fabric slip cover is enclosed after being placed on the plastic wipe container, such that it is securely closed and cannot fall off unless it is unsealed by the user, wherein the seal or enclosure is accomplished by using any method including but not limited to Velcro, snaps, zipper, magnet, buttons, hook and eyes, ties, or reusable tape.

### SUMMARY OF THE INVENTION

The present invention uses a novel design and manufacturing system to provide a more useful and convenient decorative fabric slip cover for baby wipe cases.

One object of the present invention is to provide a method of manufacture such that the fabric cover of the wipe case can easily slip on and slip off for purposes of cleaning, adding wipes to the case, or placing on a different case.

Another object of the invention is a method to seal the fabric cover once it is slipped on the wipe case such that it will not fall off.

Another object of the invention is a method of manufacture such that the fabric cover has a matching dispensing tab to that of the wipe case, such that the wipe case can be used as originally intended, and further that the fabric dispensing tab is connected to the wipe case dispenser tab for further convenience, and further, that the fabric dispenser tab will allow for easier opening of the wipe case dispenser tab which is often sealed so tightly that many people have difficulty opening the tab.

Another object of the invention is a method of manufacture such that additional pieces of fabric are attached to the back or any place on the fabric slip cover, with its own enclosure system, that forms a pocket or strap that is intended to store diapers or any other desired items.

### BRIEF DESCRIPTION OF THE SEVERAL VIEWS OF THE DRAWINGS

The above and other objects, features, and advantages of the present invention are further described in the detailed description which follows, with reference to the drawings by way of non-limiting exemplary embodiments of the present invention, wherein like reference numerals represent similar parts of the present invention throughout the several views and wherein:

FIG. 1 is a top view of a typical small plastic wipe dispenser

FIG. 2 is a view of a typical small plastic wipe dispenser with the plastic opening dispensing tab shown in the open position

FIG. 3 shows how the decorative slip cover is placed on the plastic wipe case

FIG. 4 shows the decorative slip cover completely secured on the plastic wipe case

FIG. 5 shows how the wipe dispensing tab will be open with the fabric cover secured to the dispensing tab.

FIG. 6 shows a fabric slip cover designed for a larger size plastic wipe case and where the opening of the fabric slip cover on the bottom is

FIG. 7 shows the larger size fabric slip cover fully secured on the plastic wipe case

FIG. 8 shows the additional fabric cuts to make a pocket or strap with securing tabs to hold diapers or any other personal items.

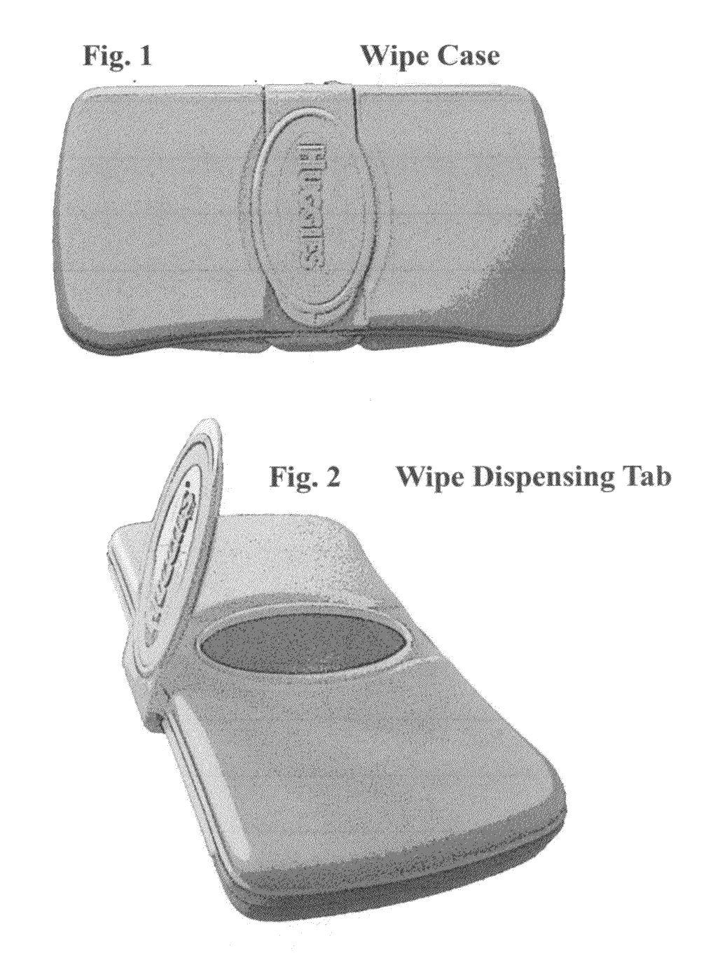

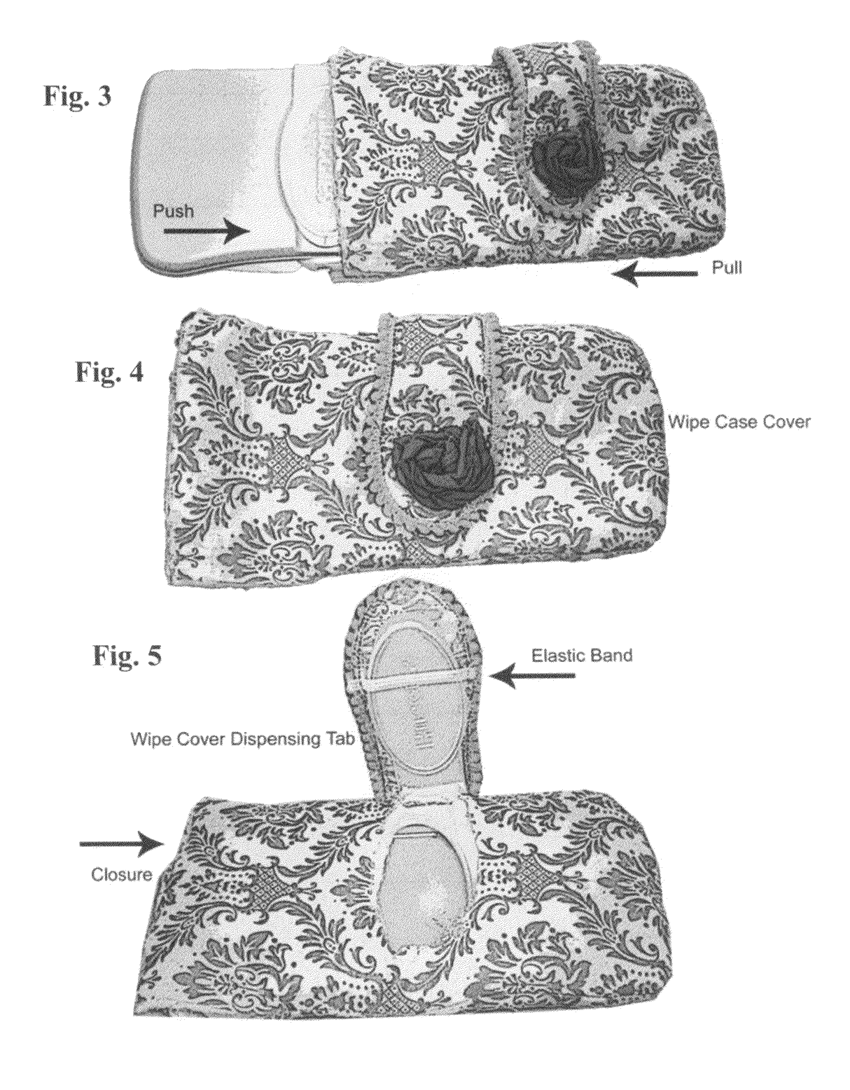

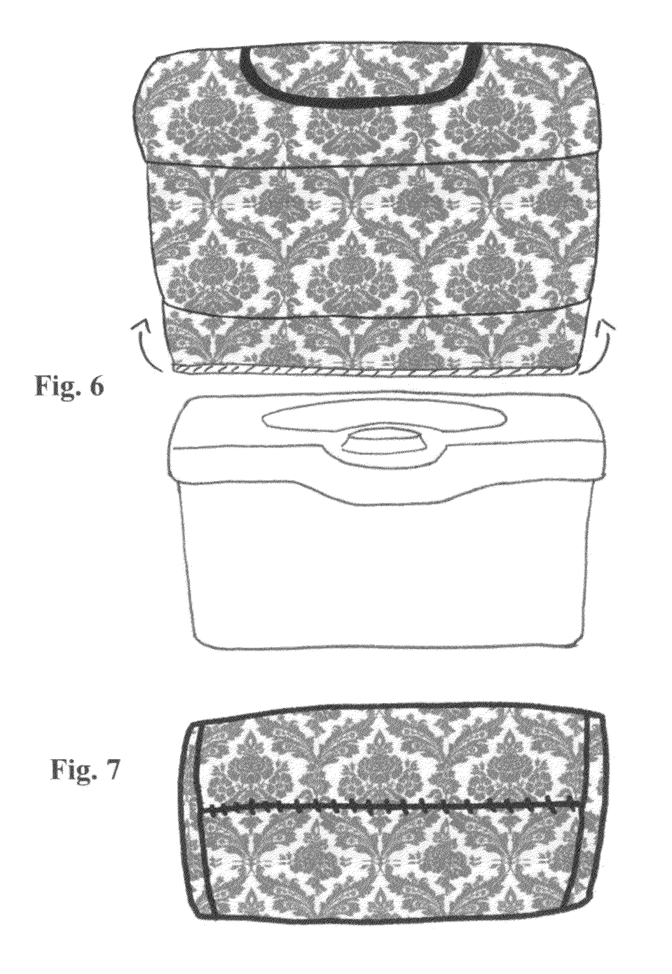

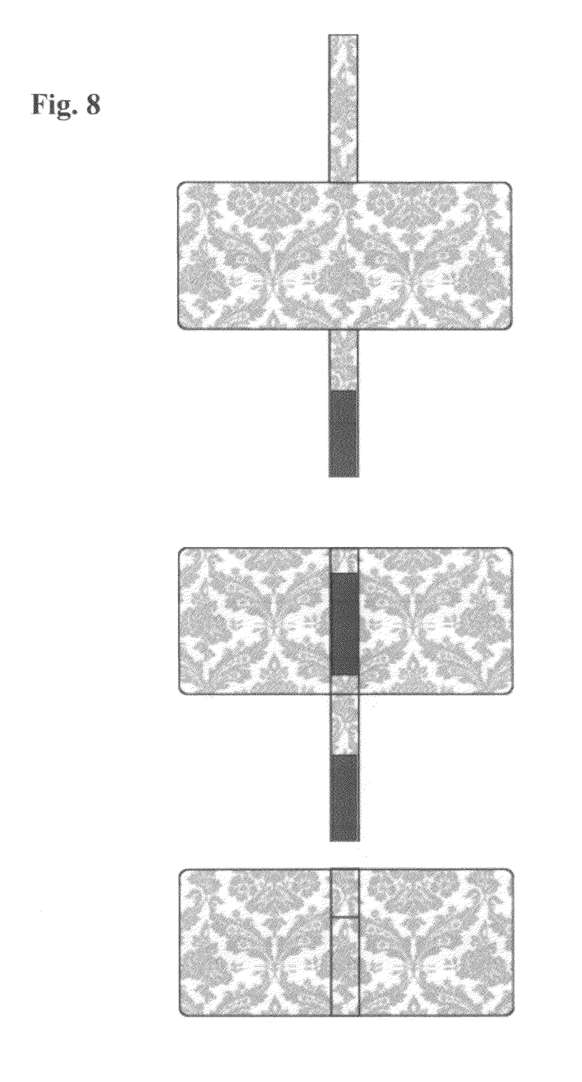

### DETAILED DESCRIPTION OF THE INVENTION

The present invention relates to a method decorative fabric cover for baby wipe cases, which are typically made of plastic. These baby wipe cases can be of various sizes and used for home or in smaller sizes used for travel. There are many people who use craft skills to make decorative covers for baby wipe cases, however, they are typically permanently attached to the wipe case making removal for washing difficult, and do not allow for only the wipe case tab to be opened to dispense wipes.

Fabric is cut and sewn or secured in some manner to match the size and shape of a plastic wipe case with a firm fit that can slide on and off. The wipe cover can be made of any type of commercially available fabric or leather, or bicast polyurethane leather. A cut out of the fabric is made that matches the shape of the opening tab of the plastic wipe container, and a method of securing the fabric to the opening tab of the plastic wipe container is provided via any method including but not limited to an elastic band, Velcro, zipper, magnet, buttons, hook and eyes, ties, or reusable tape. Any decorative pieces of fabric, plastic, buttons, or gems may be added as a decorative factor.

Disposable wet wipes are added to the plastic wipe case as purchased by a consumer.

The fabric slip cover is then placed around the plastic wipe case by sliding over the case; the end of the fabric slip cover is then closed and secured with fasteners. Fasteners can be of any material or type including but not limited to Velcro, magnets, snaps, zipper, or reusable tape.

The fabric dispensing tab cover, as part of the fabric slip cover, is then secured to the plastic wipe case dispensing tab via any means including but not limited to an elastic band, Velcro, reusable tape, zipper, or magnets.

There are many different plastic wipe cases provide by different manufacturers. These wipe cases come in various sizes and shapes, with various types of dispensing tabs. In order to accommodate for the variety of sizes and shapes, measurements are taken of the plastic wipe case and a pattern of fabric is measured and cut to fit the measured specifications of the plastic case. The securing method of fasteners (Velcro, snaps, etc.) are then added to the fabric, a cut out made of the plastic case dispensing tab, and the dispensing tab attachment is added (elastic band, Velcro, magnets, etc.). Finally, any desired decorative pieces are attached to the exterior of the cover.

It is also possible to manufacture and use the fabric slip cover without a dispensing tab piece if desired, whereby the consumer would use the dispensing tab as usual without the fabric attachment.

Although the detailed description herein contains many specifics for the purposes of illustration, anyone of ordinary skill in the art will appreciate that many variations and alterations to the following details are within the scope of the embodiments described herein. Thus, the following illustrative embodiments are set forth without any loss of generality to, and without imposing limitations upon, the claimed invention.

What is claimed is:

1. A design and method of manufacturing a decorative fabric slip cover for plastic baby wipe cases, wherein such fabric cover is able to easily slide on and off the plastic case, and seal the open end closed via any means including but not limited to Velcro, snaps, magnets, zippers, or reusable tape, and wherein the slip cover is designed and manufactured in such as way as to have an opening for the wipe dispensing tab of the plastic wipe case, and wherein the fabric opening tab is securely fastened to the plastic wipe dispensing tab via any means including but not limited to an elastic band, Velcro, or snaps.

2. A design as in claim 1 wherein a decorative fabric slip cover can be manufactured to the same general specifications for any size and shape plastic wipe case cover.

3. A design as in claim 1 wherein the open end can be sealed shut via any means including but not limited to Velcro, magnets, or snaps, for any size and shape plastic wipe case cover, so that the decorative fabric cover will stay securely fastened on the plastic wipe case cover.

4. A design as in claim 1 wherein the end of the fabric slip cover can easily be unsealed via any means including but not limited to unpeeling Velcro, unsnapping snaps, or pulling apart magnets, such that the fabric slip cover is then opened and easily able to slide off the plastic wipe case.

5. A design as in claim 1 wherein the manufacture of the fabric slip cover is made with a matching opening to that of the plastic wipe dispensing tab, and securely fastened to such dispensing tab via any means including but not limited to an elastic band, Velcro, or reusable tape, and wherein the dispensing tab can be opened by pulling on the fabric tab opening such that wipes can be removed from the plastic wipe case as designed without the need for removing the entire decorative plastic slip cover.

6. A design and method of manufacturing a decorative fabric slip cover for plastic baby wipe cases, wherein additional pieces of fabric are attached to the back of the fabric slip cover that can form a pocket type enclosure or strap when enclosed via any means including but not limited to Velcro, snaps, zipper, or magnet, where such additional fabric forms a storage pocket or strap for storage of additional items.
